(19) United States
(12) Patent Application Publication
(10) Pub. No.: US 2006/0255915 A1
(43) Pub. Date: Nov. 16, 2006

(54) Light alert system for a pager

(76) Inventor: Rae Steele, Poughkeepsie, NY (US)

Correspondence Address: SCULLY SCOTT MURPHY & PRESSER, PC, 400 GARDEN CITY PLAZA, SUITE 300, GARDEN CITY, NY, 11530, US

(21) Appl. No.: 11/128,491

(22) Filed: May 13, 2005

(51) Int. Cl. G08B 5/22

(52) U.S. Cl. 340/7.61

(57) ABSTRACT

A light alert system and apparatus for a pager device or beeper are described. The system includes a light alert base apparatus that includes: a contact area configured to contact with the pager device; an activation sensor that detects that a signal has been received by the pager device at the contact area, for example, by detecting a vibration, light or audio output of the pager; and a strobe light configured to provide a widely disbursed alerting light when activated in response to detection by the activation sensor that the signal has been received by the pager device. Also, the contact area may include a contact sensor that deactivates the strobe light when the presence of the pager device is removed from said contact area. Such a system may be of use, for example, by hearing-impaired users.

### FIELD OF THE INVENTION

The present invention is related to the field of paging devices, and to paging notification and alert systems.

### BACKGROUND OF THE INVENTION

In recent years, the use of pagers, also sometimes known as “beepers,” has become very popular to alert a user about an event, to request that the user telephone a caller, to send a message, such as a text message or alphanumeric message, or the like. However, it is often the case that a user of the pager is not carrying the pager on his or her person but still wishes to be made aware of the receipt of a signal or message by the pager. For example, the user may be at home in an adjacent room to where the pager is located, therefore unable to be alerted by the pager in the pager's vibration mode.

This is also of concern to a hearing-impaired user who is not in physical contact with the pager. For example, a hearing-impaired user in an adjacent room from the pager, or even in the same room as a pager but not in physical contact with it, would not be alerted by the vibration of the pager when activated. Although some pagers are equipped with lights or LED displays that are activated when the pager is activated, this would often be insufficient to alert a user some distance away or in adjacent room from the pager.

Corbus, U.S. Patent Application Publication No. 2004/0207533, discloses a night light equipped charging station for a pager that is designed for the particular use of emergency response personnel such as firemen, which emits a small focused beam of light in an adjustable direction to alert only a specified user of the activation of the pager when at the charging station. However, Corbus is not directed to alerting people in a larger area, or other adjacent areas using a strobe light. Thus, Corbus would not satisfy the requirements of, for example, a person in an adjacent room from the pager, or a hearing-impaired user.

Strobe lights that notify when a telephone rings have also been developed. However such devices are not designed for alerting a user that a pager or beeper has received a message. Since such devices work with ordinary telephones and ordinary telephone rings, such devices would be impractical for the deaf community.

### SUMMARY OF THE INVENTION

A light alert system for a pager device is described. The system includes a light alert base apparatus that includes: a contact area configured to contact with the pager device; an activation sensor configured to detect that a signal has been received by the pager device at said contact area; and a strobe light configured to provide a widely disbursed alerting light when activated in response to detection by said activation sensor that the signal has been received by the pager device.

The contact area may also include a contact sensor configured to deactivate said strobe light when the presence of the pager device is removed from said contact area.

The activation sensor may detect that a signal has been received by the pager device by a vibration of the pager device, by an LED activation of the pager device, or by a sound emitted from the pager device.

The light alert system may also be equipped with a time expiration control configured to allow a user to set the deactivation of said strobe light at the expiration of a predefined time period measured from the activation of the strobe light. Such a predefined time period may be approximately 30 seconds, 10 seconds, or some other period of time.

Also provided is a light alert base apparatus for use in a vehicle, in which instead of a strobe light, another less disruptive type of light could be used.

A remote alert unit may also be connected to the light alert base apparatus via a wireless or wired connection. Such a remote alert unit includes an additional strobe light activated when the strobe light of the light alert base apparatus is activated.

### BRIEF DESCRIPTION OF THE DRAWINGS

FIG. 1 illustrates the wiring diagram of the strobe light according to an embodiment of the present invention.

FIG. 2 illustrates the wiring diagram of a light alert apparatus according to an embodiment of the present invention.

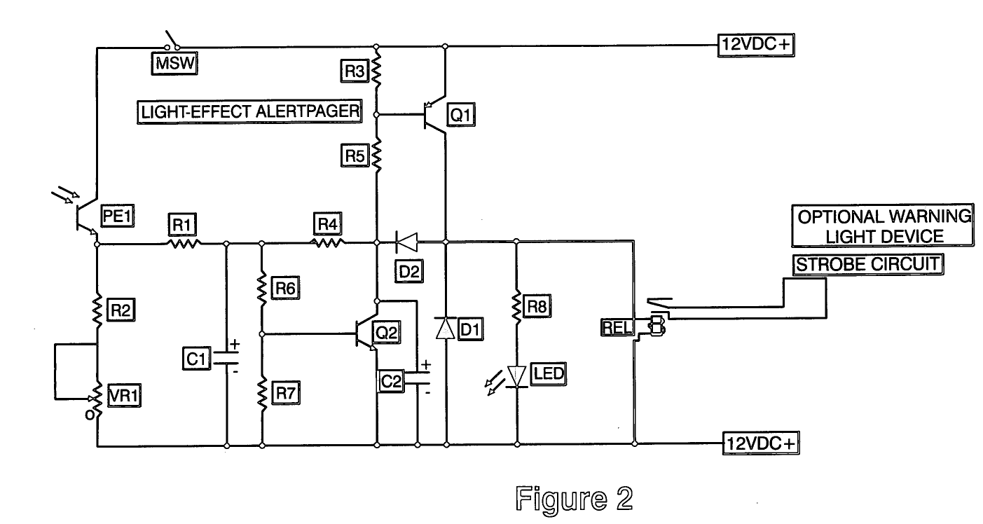

FIG. 3 illustrates the vibration and audio block of a light alert apparatus according to embodiment of the present invention.

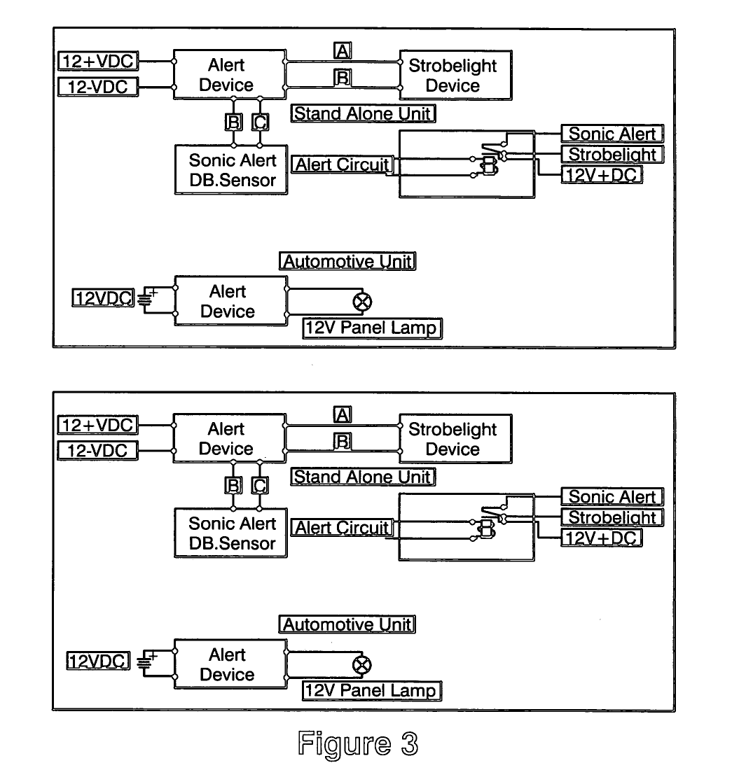

FIG. 4 illustrates a vibration audio circuit of the light alert apparatus according to embodiment of the present invention.

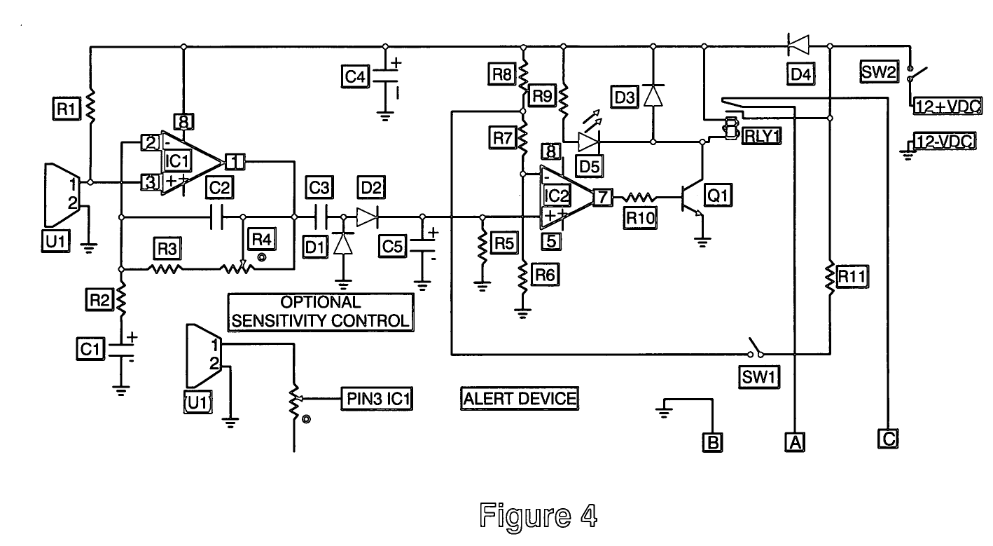

FIG. 5 is a schematic of an embodiment of a light alert system according to the present invention.

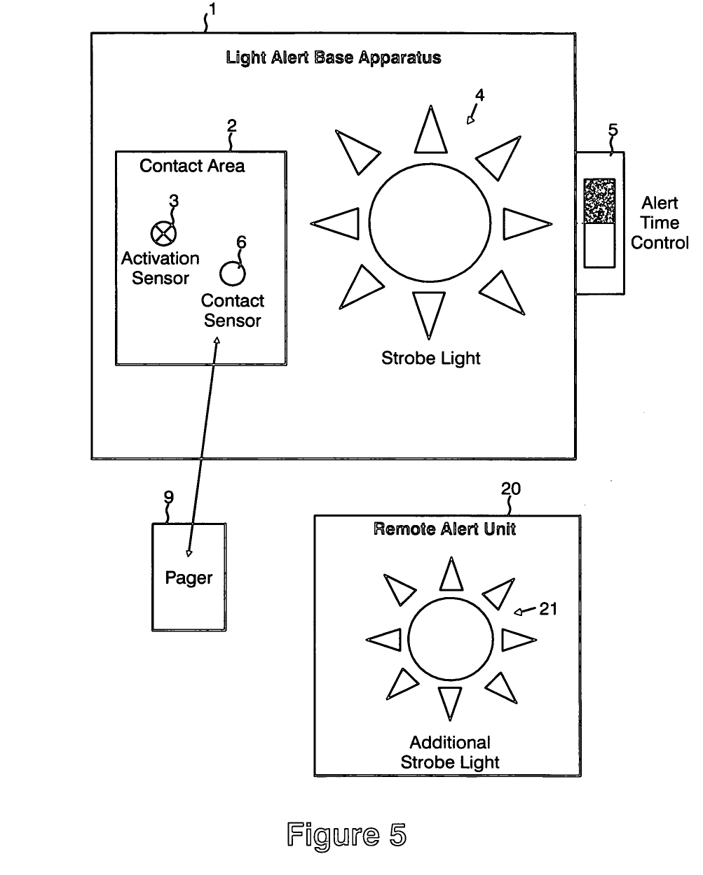

### DETAILED DESCRIPTION OF THE INVENTION

The following discussion and the foregoing figures describe embodiments of Applicant's invention as best understood presently by the inventors however, it will be appreciated that numerous modifications of the invention are possible and that the invention may be embodied in other forms and practiced in other ways without departing from the spirit of the invention. Further, features of embodiments described may be omitted, combined selectively or as a whole with other embodiments, or used to replace features of other embodiments, or parts thereof, without departing from the spirit of the invention. The figures and the detailed description are therefore to be considered as an illustrative explanation of aspects of the invention, but should not be construed to limit the scope of the invention.

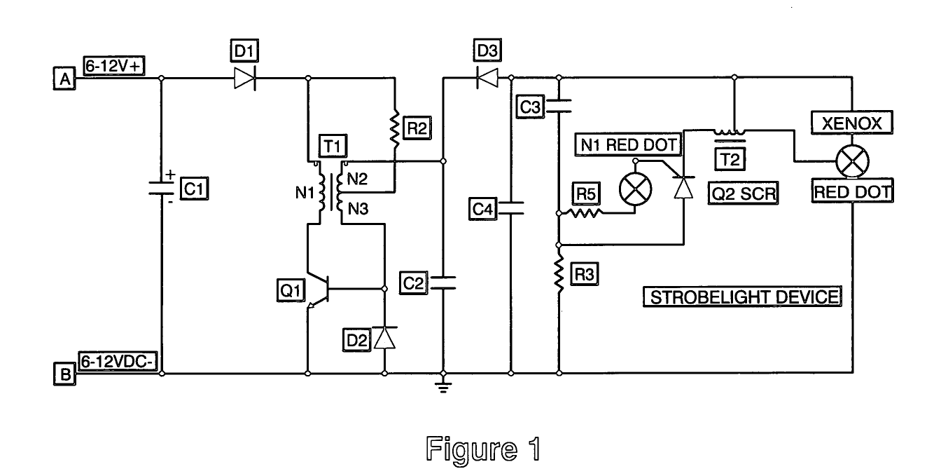

An overall structure of a light alert apparatus according to an embodiment of the present invention will now be described with reference to FIG. 1. Light alert apparatus 1 shown in FIG. 1 includes a contact area 2 with which pager 9 is placed in contact when user wishes to make use of the light alert system including the light alert apparatus 1. The pager 9 may be any type of pager or beeper, including a pager that includes a digital LCD display, a pager that notifies the user that a signal or message has been received by a vibration, an alert displayed on the LCD display, a light, for example an LED light, an audio message, ring, beep tone or alert signal, or any combination of the foregoing types of notification. This notification of the pager 9 is detected by activation sensor 3, which triggers the activation of the strobe light 4.

The pager 9 may also provide for other types of text messaging communications and/or other types of handheld device functionality, personal communicator or personal digital assistant (PDA) functionality, or the like. Typically, pager 9 notifies the user that a signal or message has been received. Such a message may include a telephone call made to a telephone number associated with the pager, a text message sent to an e-mail address associated with the pager, or some other type of signal or message.

The pager 9 could be made to make physical contact with the contact area 2 of the light alert apparatus 1 of FIG. 1 or may be placed in proximity with the contact area 2 without direct physical contact. Also, the pager 9 need not necessarily be made to make contact with or be in the proximity of the contact area 2 so long as a notification of the pager 9 provided to the user is detected by the light alert apparatus 1. The contact area 2 may also include an activation sensor 3 that detects that the pager 9 is attempting to notify the user via the above-discussed vibration, lights, or audio notification, and thereby activate the light alert apparatus 1. For example, activation sensor may detect a vibration of the pager 9. Strobe light 4 of the light alert apparatus 1 of FIG. 1 is activated responsive to the detection by the activation sensor 3 of the notification of the pager 9. It will be understood that the activation sensor 3 need not necessarily be provided in the contact area 2. So long as the activation sensor 3 is able to detect the notification of the pager 9 that a signal has been received it may be provided on some other portion of the light alert apparatus 1.

Contact sensor 6 detects the presence of the pager 9 at or near the contact area 2 and activates the light alert apparatus 1, including the strobe light 4 when it detects that the pager 9 has been removed from the contact area 2. It will be understood that contact sensor 6 and activation sensor 3 may be implemented as a single sensor that performs both functions: detecting the presence/removal of the pager 9 and detecting the vibration, light, display and/or sound notification of the pager 9.

In a second embodiment, the light alert base apparatus is configured for use in a vehicle, such as an automobile, truck, ambulance, boat, aircraft, or the like. Instead of a strobe light, another less disruptive type of light could be used, so as to create less of a hazard or burden on the driver or on traffic. Any one or more of several types of lights could be used, such as bright LEDs, neon lights, bulbs, or other types of lighting systems suitable for providing a bright light or flood light to alert all present in the area or room that the pager 9 has received a signal or message. According to an aspect of the present invention, such a light alert base apparatus could be powered by a cigarette lighter power source or other type of power outlet of a car or automobile. Further, the apparatus according to the second embodiment may be used for environments or applications other than a vehicle, where a less burdensome light is desired.

Remote alert unit 20 may be placed in an adjacent room or in areas more distant from the light alert apparatus 1. Remote alert unit 20 receives a signal to activate additional strobe light 21 from a transmitter in the light alert apparatus 1 when the strobe light 4 of light alert apparatus 1 is activated. According to an aspect of the present invention, remote alert unit 20 is connected to light alert apparatus 1 via a wireless connection, such as a radio frequency signal, and is automatically activated to notify a nearby user when the light alert apparatus 1 is activated. However it will be understood that other types of connection with the light alert apparatus 1, such as a wired connection, a low-frequency audio connection or the like may also be used to connect to the remote alert unit 20 with the light alert apparatus 1.

The strobe light 4 and additional strobe light 21 may be bright strobe lights and may provide a flashing light signal when activated. It will be understood that such a strobe light could be made in several ways. Also, strobe light 4 and additional strobe light 21 may each include more than one lighting unit to provide an easily noticeable alert lighting effect. Also, several strobe lights may be provided on the light alert apparatus 1 and on the additional strobe light 21 so that the light is visible from different areas of the room or so that different colors or lighting patterns are provided.

Alert time control 5 of the light alert apparatus 1 allows the user to choose a setting in which the strobe light 4 will be automatically deactivated after a period of time. For example, alert time control 5 may provide a setting which automatically shuts off the strobe light 30 seconds after the activation of the strobe light 4, even if the user does not react to the activation of the strobe light 4 of the light alert apparatus 1.

An operation of an embodiment of the light alert apparatus 1 will now be described with reference to FIG. 1. A user wishes to be alerted to a signal or message received by the pager 9 but does not wish to carry the pager 9 on his or her person. User positions pager 9 at or near contact area 2 of the light alert apparatus 1, for example after arriving home. For example light alert apparatus 1 may be positioned in the user's living room such that an activation of the strobe light 4 is visible from anywhere in the living room and from most of the bedroom. Remote alert unit 20 could be positioned, for example, in the kitchen, bathroom, deck, backyard, garage or basement. According to an embodiment of the present invention, light alert apparatus 1 may be positioned in an automobile or other type of vehicle. The foregoing are merely illustrations of some typical positions for the foregoing devices, however other positions are also contemplated by the inventor.

When pager 9 receives a signal, it provides the type of notification discussed above, such as a vibration, a light and/or an audio alert ring or message to attempt to notify the user that signal has been received. Activation sensor 3 detects the notification of the pager 9, and thereby light alert apparatus 1 activates the strobe light 4. If the remote alert unit 20 is also deployed, then the additional strobe light 21 is also activated pursuant to the signal of the light alert apparatus 1 to the remote alert unit 20.

The user, seeing the strobe light 4 and/or the additional strobe light 21 is thus made aware that pager 9 has received a signal. The user may remove pager 9 from its position at or near contact area 2 to obtain more information about the incoming signal or message on the pager 9. Thereby contact sensor 6 detects the removal of the presence of the pager 9 from at or near contact area 2, and causes strobe light 4 and additional strobe light 21 to be deactivated.

If the user does not remove pager 9 from at or near the contact area 2, then the strobe light 4 (and additional strobe light 21, if the remote alert unit is being used) may still be shut off after a predetermined time according to the alert time control setting 5. As discussed, the user may set the alert time control 5 to a setting that automatically shuts off the strobe lights at the expiration of a predetermined time measured from the activation of the strobe light 4. For example, the alert time control 5 may specify that 30 seconds, or 10 seconds, or at the expiration of some other predetermined time period measured from the activation of the strobe light 4, the strobe light 4 and additional strobe light 21 is automatically shut off even without user input or action. Alternatively, the user may wish not to set the alert time control 5 to automatic shut off, and thereby allow the strobe light 4 and additional strobe light 21 to remain activated indefinitely until intervention by the user.

The present invention has been described herein with reference to particular exemplary embodiments. These exemplary embodiments are meant to be illustrative, not limiting of the scope of the invention.

What is claimed is:

1. A light alert system for a pager device, said system including a light alert base apparatus comprising:
a contact area configured to contact with the pager device;
an activation sensor configured to detect that a signal has been received by the pager device at said contact area; and
a strobe light configured to provide a widely disbursed alerting light when activated in response to detection by said activation sensor that the signal has been received by the pager device.

2. The light alert system of claim 1, wherein said contact area comprises a contact sensor configured to deactivate said strobe light when the presence of the pager device is removed from said contact area.

3. The light alert system of claim 1, wherein said activation sensor detects that a signal has been received by the pager device by a vibration of the pager device.

4. The light alert system of claim 1, wherein said activation sensor detects that a signal has been received by the pager device by an LED activation of the pager device.

5. The light alert system of claim 1, wherein said activation sensor detects that a signal has been received by the pager device by a sound emitted from the pager device.

6. The light alert system of claim 1, further comprising a time expiration control configured to allow a user to set the deactivation of said strobe light at the expiration of a predefined time period measured from the activation of the strobe light.

7. The light alert system of claim 6, wherein the predefined time period is approximately 30 seconds.

8. The light alert system of claim 6, wherein the predefined time period is approximately 10 seconds.

9. The light alert system of claim 1, further comprising a remote alert unit connected to the light alert base apparatus: via at least one of a wired connection and a wireless connection, said remote alert unit comprising an additional strobe light configured to be activated when the strobe light of the light alert base apparatus is activated.

10. A light alert apparatus for a pager device, said apparatus configured to be deployed in a vehicle and comprising:
a contact area configured to contact with the pager device;
an activation sensor configured to detect that a signal has been received by the pager device at said contact area; and
a light configured to provide a widely disbursed alerting light when activated in response to detection by said activation sensor that the signal has been received by the pager device.

11. The apparatus of claim 10, wherein said contact area comprises a contact sensor configured to deactivate said strobe light when the presence of the pager device is removed from said contact area.

12. The apparatus of claim 10, wherein said activation sensor detects that a signal has been received by the pager device by a vibration of the pager device.

13. The apparatus of claim 10, wherein said activation sensor detects that a signal has been received by the pager device by an LED activation of the pager device.

14. The apparatus of claim 10, wherein said activation sensor detects that a signal has been received by the pager device by a sound emitted from the pager device.
